(19) United States
(12) Patent Application Publication
(10) Pub. No.: US 2013/0162031 A1
(43) Pub. Date: Jun. 27, 2013

(54) Operating Structure for an Electrically Operated Vehicle

(71) Applicants: Marek Galek, Munchen (DE); Gerd Griepentrog, Gutenstetten (DE); Thomas Komma, Ottobrunn (DE); Mirjam Mantel, Munchen (DE); Jürgen Rupp, Erlangen (DE)

(72) Inventors: Marek Galek, Munchen (DE); Gerd Griepentrog, Gutenstetten (DE); Thomas Komma, Ottobrunn (DE); Mirjam Mantel, Munchen (DE); Jürgen Rupp, Erlangen (DE)

(21) Appl. No.: 13/821,143

(22) PCT Filed: Sep. 13, 2011
(86) PCT No.: PCT/EP2011/065854

§ 371 Date: Mar. 6, 2013

(30) Foreign Application Priority Data
Sep. 17, 2010 (DE) 10 2010 040 972.3

(51) Int. Cl. B60L 11/18

(52) U.S. Cl. CPC B60L 11/1811
USPC 307/10.1

(57) ABSTRACT

An operating structure for an electrically operated vehicle is disclosed, in which the windings of the electric motor are used as inductors for power factor correction during charging of the vehicle by means of the vehicle-dedicated convertor. The windings are interconnected in such a way that little or no torque is generated in the motor during the charging operation.

### CROSS-REFERENCE TO RELATED APPLICATIONS

This application is a U.S. National Stage Application of International Application No. PCT/EP2011/065854 filed Sep. 13, 2011, which designates the United States of America, and claims priority to DE Patent Application No. 10 2010 040 972.3 filed Sep. 17, 2010 The contents of which are hereby incorporated by reference in their entirety.

### TECHNICAL FIELD

The disclosure relates to an operating structure for an electrically operated vehicle having one or more electric motors, an accumulator or battery for supplying energy to the electric motor and a converter that is connected to the electric motor for supplying the electric motor with electrical energy from the accumulator.

### BACKGROUND

Electrically operated vehicles such as electric cars are driven by means of one or more electric motors in place of the conventional combustion engine. In contrast to rail-borne vehicles or trolley buses, the electric energy cannot be drawn continuously from a line, but rather said electrical energy must be provided from an energy storage device (=accumulator, battery).

For this purpose, the energy storage device is part of an electronic power operating structure that comprises at least one converter between the energy storage device and the electric motor. The converter generates a typically three-phase voltage from the DC voltage of the energy storage device. Conversely, the converter is also mainly able to feed back into the energy storage device any energy that is generated during the brake applications and to perform for this purpose a voltage rectification procedure.

The energy storage device must be charged occasionally. For future electrically operated vehicles, the energy storage device can store extremely large quantities of energy in order to provide an acceptable travel range for the electrically operated vehicles. In order to be able to charge these large quantities of energy in turn in an acceptable time into the energy storage device, a charging capacity is required that is high in comparison to present-day capacities in private households. For this purpose, it may be preferred that high-power rated controlled converters that comprise power factor control (PFC) filters are used.

An external charging device that is embodied accordingly can be used to charge the energy storage device. It is also known to use as a charging device the converter that is provided in the vehicle. For this purpose, said converter is connected to the supply network by way of suitable impedances. It may be preferred in this case that the three-phase connection is selected, since otherwise the energy that can be drawn off is considerably less and the charging procedure is extremely long.

A disadvantage of using an external charging device is the lack of flexibility. It is necessary for the electrically operated vehicle to be connected continuously to the charging device in order to be able to perform the charging procedure. A disadvantage of a charging device in the form of the converter having the PFC impedances being provided in the vehicle itself has the disadvantage that although the converter can to a great extent remain unchanged, it is, however, necessary to install impedances that are large and heavy due to the high power rating and this makes the car heavier.

### SUMMARY

One embodiment provides an operating structure for an electrically operated vehicle having: at least one electric motor, an accumulator for storing and supplying electrical energy, a converter that is connected to the electric motor for supplying the electric motor with electrical energy from the accumulator, and connection options for connecting a three-phase supply network and the operating structure, embodied in such a manner that for a motor operation the windings of the motor for the phases can be connected to a neutral point, and for a charging operation for charging the accumulator at least two of the phases of the supply network can be connected to the converter by way of in each case at least one winding of the electric motor, wherein the connection to the neutral point can be interrupted.

In a further embodiment, switching options are provided with which during the charging operation the windings of the electric motor can be connected in such a manner that as a result of the current flow during the charging operation no torque or only an extremely small amount of torque is generated in the electric motor.

In a further embodiment, the electric motor is multi-pole and its stator winding comprises a plurality of part windings, during the motor operation first part windings are allocated to a first phase, second part windings are allocated to a second phase and third part windings are allocated to a third phase, and the switching options are embodied in such a manner that during the charging operation a part of the first part windings and also a part of the second part windings can be connected to the first phase of the supply network and a further part of the first part windings and also a further part of the second part windings can be connected to the second phase of the supply network.

Another embodiment provides an operating method for an electrically operated vehicle, wherein at least one electric motor is supplied by means of a converter that is connected to the electric motor with energy from an accumulator for storing and supplying electrical energy, during a motor operation the windings of the motor are connected for the phases to a neutral point, and during a charging operation for charging the accumulator at least two of the phases of a supply network that is to be connected are connected to the converter by way of in each case at least one winding of the electric motor, wherein the connection to the neutral point is interrupted.

In a further embodiment, during the charging operation the windings of the electric motor are connected in such a manner that as a result of the current flow during the charging operation no torque or only an extremely small amount of torque is generated in the electric motor.

In a further embodiment, a multi-pole electric motor is used, the stator winding of which comprises a plurality of part windings, wherein during the motor operation first part windings are allocated to a first phase, second part windings are allocated to a second phase and third part windings are allocated to a third phase, and wherein during the charging operation a part of the first part windings and also a part of the second part windings are connected to the first phase of the supply network and a further part of the first part windings and also a further part of the second part windings are connected to the second phase of the supply network.

### BRIEF DESCRIPTION OF THE DRAWINGS

Exemplary embodiments will be explained in more detail below based on the schematic drawings, wherein:

FIG. 1 shows a greatly simplified operating structure for an electric vehicle,

FIG. 2 shows a connection diagram for charging the battery,

FIG. 3 shows an operating structure having a multi-pole motor connected for the drive operation,

FIG. 4 shows an operating structure having a multi-pole motor connected for the motor operation,

FIG. 5 shows an operating structure having a multi-pole motor connected for the charging operation, and

FIG. 6 shows an operating structure having a multi-pole motor connected for the motor operation.

### DETAILED DESCRIPTION

Embodiments of the present disclosure provide an operating structure for an electrically operated vehicle that avoids the mentioned disadvantages. In so doing, it is to be assumed that no external charging device is to be used, in other words the vehicle's own converter is to be used.

Some embodiments provide an operating structure for an electrically operated vehicle that comprises at least one electric motor, an accumulator for storing and supplying electrical energy and at least one converter that is connected to the electric motor for supplying the electric motor with electrical energy from the accumulator.

Furthermore, connection options are included for connecting a three-phase supply network and the operating structure, wherein said options are embodied in such a manner that for a charging operation for charging the accumulator at least two of the phases of the supply network can be connected to the converter by way in each case of at least one winding of the electric motor, wherein the connection to the neutral point can be interrupted. Furthermore, it is possible for a motor operation to connect the windings of the motor for the phases to a neutral point.

It has been recognized that the windings of the electric motor can be used also for controlling the power factor. As a consequence, it is possible to omit the additional impedances and thus reduce the weight and installation space in electrically operated vehicles, which in turn increases their travel range.

In one embodiment, connection options are provided, with which it is possible during the charging operation to connect the windings of the motor in such a manner that as a result of the current flow during the charging operation no torque or only an extremely small amount of torque is generated in the motor. As a consequence, any unintentional movement of the vehicle is prevented and it is not necessary to provide a special design in order to prevent such movements.

For this purpose, it may be preferred in the case of a multi-pole electric motor, in which the stator winding comprises a plurality of part windings, that the following embodiment is selected: during the motor operation, first part windings are allocated to a first phase, second part windings are allocated to a second phase and third part windings are allocated to a third phase. Furthermore, the connection options are embodied in such a manner that during the charging operation a part of the first part windings and also a part of the second part windings can be connected to the first phase of the supply network and a further part of the first part windings and a further part of the second part windings can be connected to the second phase of the supply network.

In other words, a cross-over connection of in each case a part of the part windings of two of the three phases can be performed for the charging operation. In so doing, in each case half of the part windings are expediently connected. As a consequence, the structure of a rotating field is avoided and the generated torque is reduced to extremely small values.

In the case of the operating method for an electrically operated vehicle at least one electric motor is supplied by means of a converter that is connected to the electric motor with energy from an accumulator for storing and supplying electrical energy. Furthermore, the windings of the motor are connected for the phases to a neutral point during a motor operation and during a charging operation for charging the accumulator at least two of the phases of a supply network that is to be connected are connected to the converter by way of in each case at least one winding of the electric motor, wherein the connection to the neutral point is interrupted. It may be preferred that during the charging operation the windings of the motor are connected in such a manner that that as a result of the current flow during the charging operation no torque or only an extremely small amount of torque is generated in the motor.

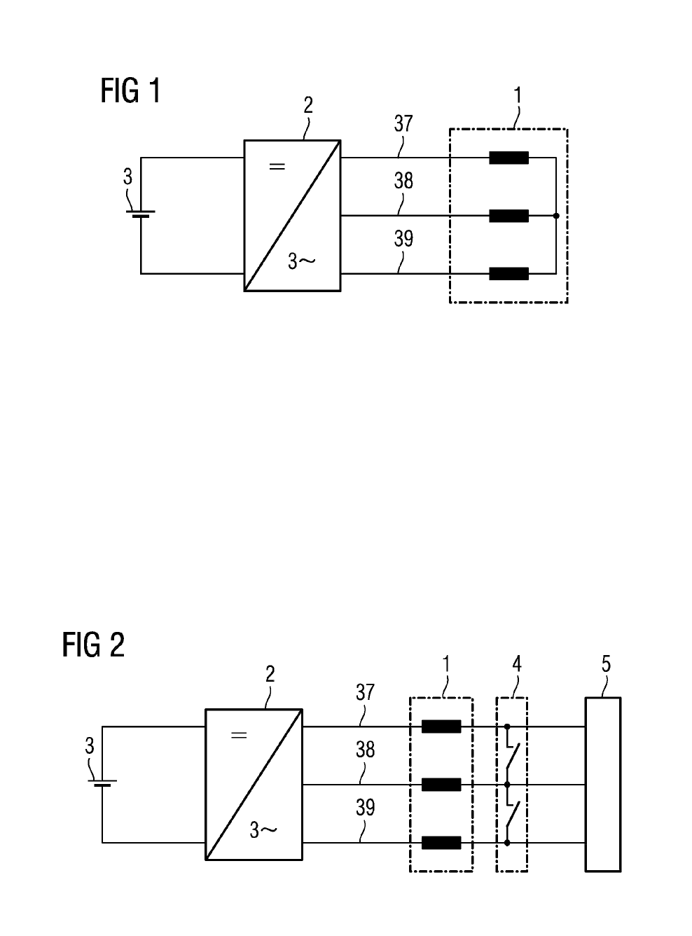

FIG. 1 illustrates an operating structure that is greatly schematic and reduced to the essential elements for operating an electric vehicle in accordance with the prior art. The structure comprises in this case an electric motor 1 that is illustrated schematically by means of its three windings. The electric motor 1 is embodied in a three-phase manner and is connected to a converter 2 by way of a first to third phase line 37 . . . 39. The converter is connected on the DC side to an accumulator 3 that is used as a drive accumulator.

The converter 2 is embodied to supply energy to the electric motor 1 from the accumulator 3 and to render it possible to feedback electrical energy into the accumulator 3. The energy is fed back, for example, during brake applications. It is necessary to perform further measures when charging the accumulator 3 from outside the vehicle.

FIG. 2 illustrates a diagram of a connection to a supply network 5 for charging the battery. Furthermore, the elements: electric motor 1, converter 2 and accumulator 3 are provided. In addition, the operating structure is then connected to a supply network 5. This connection is advantageously performed on the side of the electric motor 1 that is remote from the converter 2. As a consequence, the windings of the electric motor 1 can be used as impedances for controlling a power factor (PFC). As a consequence, the energy consumption of the converter 2 is in turn less of a loading for the supply network 5.

Owing to the fact that the supply network 5 is connected by way of the windings of the electric motor 1, it is necessary to disconnect the connection of the windings in the neutral point. A switching device 4 is provided for this purpose. The switching device 4 comprises a first switch between the first phase line 37 and the second phase line 38. Furthermore, the switching device 4 comprises a switch between the second phase line 38 and the third phase line 39. Both switches of the switching device 4 are open for a charging operation. FIG. 2 and FIGS. 4 and 6 illustrate the connection to the supply network 5 as a fixed connection. However, the connection is naturally performed by way of a plug-in system.

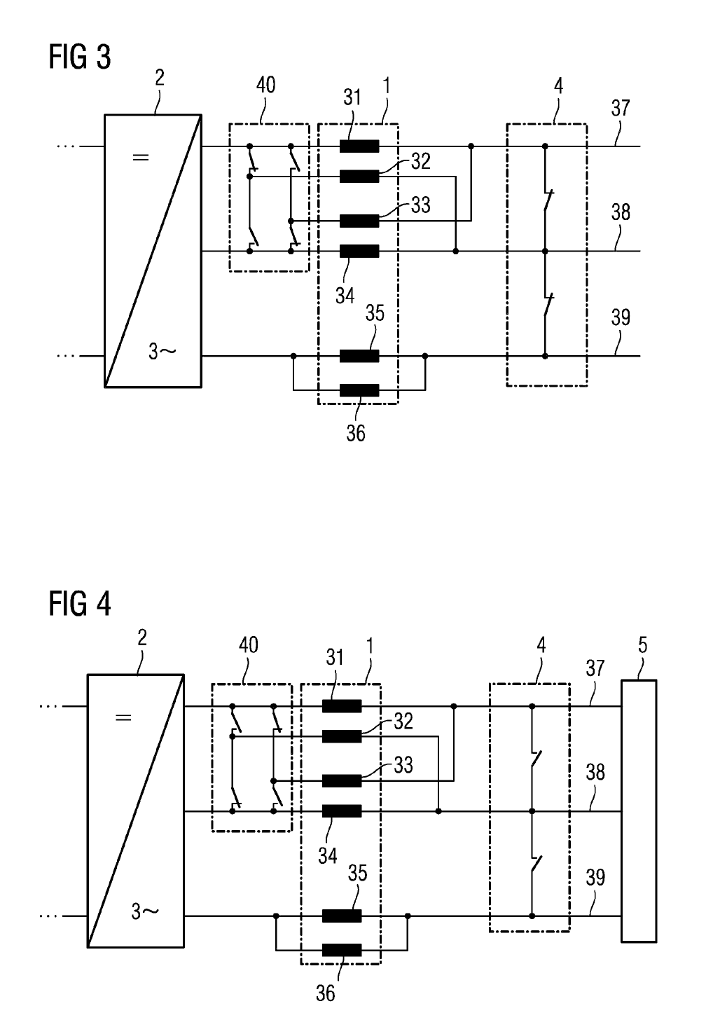

A problem of the further greatly schematized structure in accordance with FIG. 2 is that the windings of the electric motor 1 in the case of the charging operation generate a rotating field, as a consequence of which a torque is generated as is also the case during the drive operation. In order to greatly reduce this rotating field or to prevent it completely, a structure is used that is illustrated in FIGS. 3 to 6 and explained herein under.

FIG. 3 illustrates an example structure in accordance with one embodiment of the present invention. In this case, FIG. 3 indicates the drive operation, i.e. the vehicle is not connected to the supply network 5. The switching device 4 provides a connection of the phase lines 37 . . . 39 to the neutral point. For this purpose, the two switches of the switching device 4 are closed. The accumulator 3 is not illustrated in FIG. 3.

It is assumed in the structure in accordance with FIG. 3 that the electric motor 1 is a multi-pole machine having accordingly a plurality of windings 31 . . . 36 for each phase. The windings 31 . . . 36 for each phase are in this case connected in parallel. In so doing, the windings 31 . . . 36 for each phase symbolize in each case half of the actual windings of the electric motor 1.

There is no change in the third phase line 39 with respect to the known operating structure. However, changes have been introduced in the first and second phase line 37, 38.

In this case, a first winding 31 is connected in the first phase line 37 as it would be connected also in the known structure. However, the second winding 32 is connected in a different manner. Thus, the neutral point-side connection of the second winding 32 is connected not to the first phase line 37 but rather instead of that to the second phase line 38. The converter-side connection of the second winding 32 is connected to a second switching device 40. Two switches are provided in the second switching device 40 and by means of said two switches the converter-side connection of the second winding 32 is connected to the first phase line 37 and to the second phase line 38.

In the driving operation mode illustrated in FIG. 3, the converter-side connection of the second winding 32 in this case is connected to the first phase line 37 and its connection to the second phase line 38 is interrupted. Since the switching device 4 connects the phase lines 37 . . . 39 on the neutral point side, a parallel connection of the second winding 32 to the first winding 31 is effectively achieved as a consequence thereof.

A fourth winding 34 is connected in the second phase line 38 as it would be connected also in the known structure. However, the connection of the third winding 33 remains unchanged. Thus, the neutral point-side connection of the third winding is connected not to the second phase line 38 but rather instead thereof to the first phase line 37. The converter-side connection of the third winding 33 is likewise connected to the second switching device 40. Two further switches are provided in the second switching device 40 and by means of said two switches the converter-side connection of the third winding 33 is connected to the first phase line 37 and the second phase line 38.

In the driving operation mode illustrated in FIG. 3, the converter-side connection of the third winding 33 in this case is connected to the second phase line 38 and its connection to the first phase line 37 is interrupted. Since the switching device 4 connects the phase lines 37 . . . 39 on the neutral point side, a parallel connection of the third winding 33 to the fourth winding 34 is effectively achieved as a consequence thereof.

The mode and the connection during the charging operation are outlined in FIG. 4. It is evident in FIG. 4 that the supply network 5 is connected to the phase lines 37 . . . 39. As has already been indicated with respect to FIG. 2, the phase lines 37 . . . 39 must be disconnected from the neutral point and this is achieved by means of the switching device 4.

The switch positions in the second switching device 40 are then interchanged with respect to the mode in FIG. 3. Thus, the connection of the converter-side connection of the second winding 32 to the first phase line 37 is interrupted and said second winding is connected to the second phase line 38. Furthermore, the connection of the converter-side connection of the third winding 33 to the second phase line 38 is interrupted and said third winding is connected to the first phase line 37.

The cross-over connection of a part of the windings 31 . . . 36 prevents the formation of a rotational field during the charging process. As a consequence, the build-up of a disturbing torque in the electric motor 1 is prevented at least to a great extent.

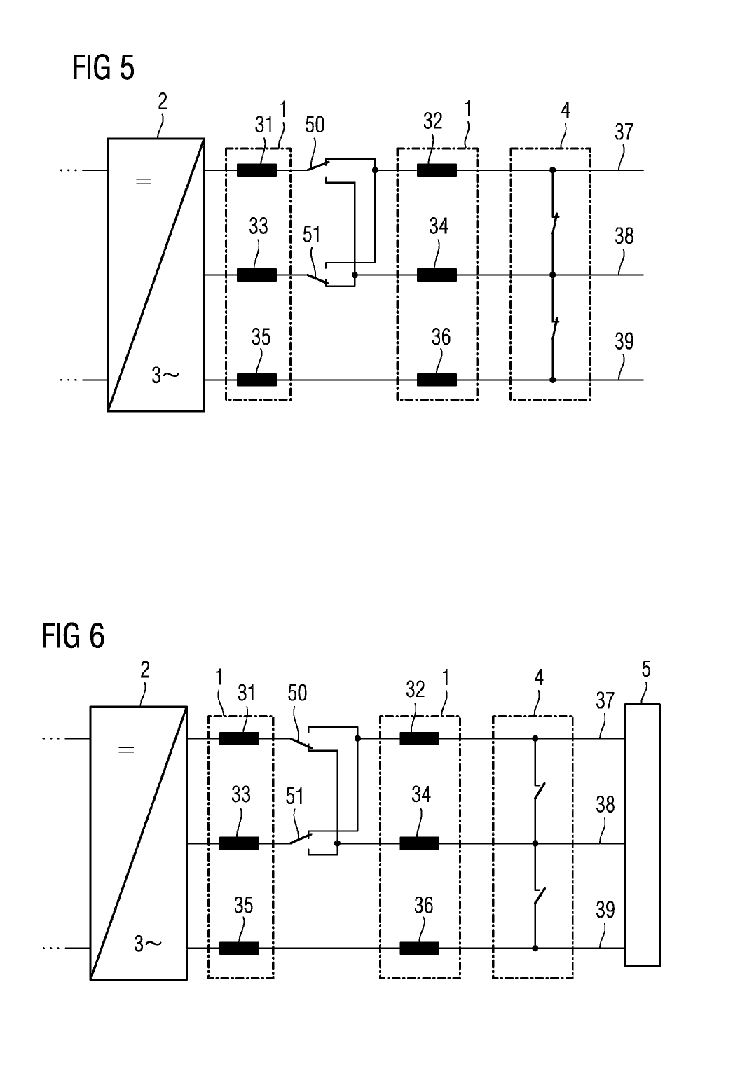

A different structure is produced if the windings 31 . . . 36 for each phase in the multi-pole electric motor 1 are connected in series. In order to reduce the formation of the rotational field in the case of this arrangement, an exemplary structure is illustrated in FIGS. 5 and 6. In this case, FIG. 5 illustrates the structure again during the driving operation and FIG. 6 illustrates the structure during the charging operation.

In the structure in accordance with FIG. 5, the first and second winding 31, 32 are arranged in series in the first phase line 37, wherein the first winding 31 is connected directly to the converter 2 and the second winding 32 is connected directly to the switching device 4. The third and fourth winding 33, 34 are arranged in series in the second phase line 38, wherein the third winding 33 is connected directly to the converter 2 and the fourth winding 34 is connected directly to the switching device 4. The fifth and sixth windings 35, 36 are arranged in series in the third phase line 39, wherein the fifth winding 35 is connected directly to the converter 2 and the sixth winding 36 is connected directly to the switching device 4. No further change is made in the third phase line 39.

A third switch 50 is provided in the first phase line 37. The third switch 50 is arranged between the first and second winding 31, 32. The third switch 50 renders it possible to provide the connection between the first and second winding 31, 32 or alternatively to provide the connection between the neutral point-side connection of the first winding 31 and the converter-side connection of the fourth winding 34.

A fourth switch 51 is provided in the second phase line 38. The fourth switch 51 is arranged between the third and fourth winding 33, 34. The fourth switch 51 renders it possible to provide the connection between the third and fourth winding 33, 34 or alternatively to provide the connection between the neutral point-side connection of the third winding 33 and the converter-side connection of the second winding 32.

During the driving operation in accordance with FIG. 5, the connection is provided between the first and second winding 31, 32. Likewise, the connection between the third and fourth winding 33, 34 is provided. The switching device 4 connects the phase lines 37 . . . 39 on the neutral point side.

During the charging operation in accordance with FIG. 6, the supply network 5 is connected in turn to the phase lines 37 . . . 39. At the same time, the switches of the switching device 4 are open in order to eliminate the short circuit in the phase lines 37 . . . 39.

Furthermore, the switch positions of the third and fourth switches 50, 51 are interchanged. The third switch 50 represents a connection between the neutral point-side connection of the first winding 31 and the converter-side connection of the fourth winding 34. The fourth switch 51 provides a connection between the neutral point-side connection of the third winding 33 and the converter-side connection of the second winding 32.

Also in the case of the structure in accordance with FIG. 6, the windings 31 . . . 36 are therefore connected during the charging operation partially in a crosswise manner in order to prevent the build-up of a rotational field. Consequently, the generation of a torque is in turn suppressed to a great extent.

What is claimed is:

1. An operating structure for an electrically operated vehicle, comprising:
at least one electric motor,
an accumulator for storing and supplying electrical energy,
a converter connected to the electric motor for supplying the electric motor with electrical energy from the accumulator, and
switchable connections for connecting a three-phase supply network and the operating structure, the switchable connections configured to:
provide for a motor operation the windings by connecting the motor for the phases to a neutral point, and
provide for a charging operation for charging the accumulator by connecting each of at least two of the phases of the supply network to the converter via at least one winding of the electric motor, and interrupting the connection to the neutral point.

2. The operating structure of claim 1, the switchable connections comprising switches connected during the charging operation the windings of the electric motor in such a manner that as a result of current flow during the charging operation little or no torque is generated in the electric motor.

3. The operating structure of claim 2, wherein:
the electric motor is multi-pole and its stator winding comprises a plurality of part windings,
during the motor operation, first part windings are allocated to a first phase, second part windings are allocated to a second phase, and third part windings are allocated to a third phase, and
the switchable connections are configured such that during the charging operation a part of the first part windings and also a part of the second part windings are connected to the first phase of the supply network and a further part of the first part windings and also a further part of the second part windings are connected to the second phase of the supply network.

4. An operating method for an electrically operated vehicle, comprising:
supplying electrical energy from an accumulator to at least one electric motor by a converter connected to the electric motor,
for a motor operation, connecting the windings of the motor for the phases to a neutral point, and
for a charging operation for charging the accumulator, connecting each of at least two of the phases of a supply network to the converter via at least one winding of the electric motor, and interrupting the connection to the neutral point.

5. The operating method of claim 4, comprising, for the charging operation, connecting the windings of the electric motor in such a manner that as a result of a current flow during the charging operation little or no torque is generated in the electric motor.

6. The operating method of claim 5, wherein:
the electric motor comprises a multi-pole electric motor, the stator winding of which comprises a plurality of part windings,
during the motor operation, first part windings are allocated to a first phase, second part windings are allocated to a second phase, and third part windings are allocated to a third phase, and
during the charging operation, a part of the first part windings and also a part of the second part windings are connected to the first phase of the supply network, and a further part of the first part windings and also a further part of the second part windings are connected to the second phase of the supply network.
